(19) United States
(12) Patent Application Publication
(10) Pub. No.: US 2025/0381967 A1
(43) Pub. Date: Dec. 18, 2025

(54) VEHICLE

(71) Applicant: TOYOTA JIDOSHA KABUSHIKI KAISHA, Toyota-shi (JP)

(72) Inventors: Ikuma SUZUKI, Okazaki-shi (JP); Hirohito Ide, Nagoya-shi, Aichi-ken (JP); Naohiro Tohyama, Ichinomiya-shi (JP)

(73) Assignee: TOYOTA JIDOSHA KABUSHIKI KAISHA, Toyota-shi (JP)

(21) Appl. No.: 19/055,676

(22) Filed: Feb. 18, 2025

(30) Foreign Application Priority Data
Jun. 18, 2024 (JP) 2024-097949

(51) Int. Cl. B60W 50/02; B60W 50/00

(52) U.S. Cl. CPC B60W 50/0225; B60W 2050/0083

(57) ABSTRACT

The control microcomputer of the first VCIB performs processing including a step of returning when the inner IGR is in the off state, a step of acquiring the operation mode of the second VCIB, a step of executing CAN cut processing when the history is in the on state or when the history is in the off state and the operation mode of the second VCIB is in the automatic mode, and a step of continuing CAN communication when the operation mode of the second VCIB is in the manual mode.

### CROSS-REFERENCE TO RELATED APPLICATION

This application claims priority to Japanese Patent Application No. 2024-097949 filed on Jun. 18, 2024, incorporated herein by reference in its entirety.

### BACKGROUND

### 1. Technical Field

The present disclosure relates to a vehicle.

### 2. Description of Related Art

In recent years, there has been developed an autonomous driving system that causes a vehicle to travel without receiving an operation by a user. The autonomous driving system may be provided separately from a vehicle via an interface, in order to be mountable on an existing vehicle, for example.

Japanese Unexamined Patent Application Publication No. 2018-132015 (JP 2018-132015 A), for example, discloses a technique in which autonomous driving control of a vehicle is comprehensively executed by a computer that constitutes an autonomous driving system provided in the vehicle.

### SUMMARY

When an autonomous driving system is provided separately from a vehicle via an interface, a computer that constitutes the interface may be restarted due to a malfunction of the operation during the autonomous driving or the like. In this case, it is conceivable to set an autonomous driving mode as the initial value of the driving mode after the restart, in order to continue the autonomous driving even after the restart of the computer. However, a computer that constitutes an interface may be restarted by an update of software, for example, besides a malfunction of the operation. In such a case, if the autonomous driving mode is set after the restart, the same control as in the case where a malfunction of the operation is occurring is performed thereafter, and appropriate control may not be performed.

The present disclosure has been made in order to address the above issue, and an object of the present disclosure is to provide a vehicle that enables appropriate control after restart of an interface between an autonomous driving system and the vehicle.

An aspect of the present disclosure provides a vehicle including:
an autonomous driving system that performs autonomous driving of a vehicle; and
a vehicle platform that is able to receive a command related to the autonomous driving from the autonomous driving system.
The vehicle platform is subjected to vehicle control executed in an operation mode that is one of an automatic mode in which the autonomous driving system is used and a manual mode.
The vehicle platform includes a base vehicle and a vehicle control interface that interfaces between the vehicle platform and the autonomous driving system.
The vehicle control interface includes
a first control device that is able to control the base vehicle according to the operation mode, and
a second control device that is able to communicate with the first control device and is able to control the base vehicle according to the operation mode.
The first control device is configured to
set the automatic mode when the operation mode acquired from the second control device after restart of the first control device is the automatic mode, and
set the manual mode when the operation mode acquired from the second control device after the restart is the manual mode.

In this way, since the operation mode is set to the operation mode acquired from the second control device after the restart, it is possible to quickly return to the operation mode before the restart. Therefore, even if restarted due to a malfunction of the operation during the autonomous driving, the automatic mode can be continued after the restart. Therefore, it is possible to perform control corresponding to the malfunction of the operation during the autonomous driving after the restart. Further, when restarted by an update of software during the manual mode, for example, the manual mode is set after the restart, and therefore it is possible to suppress control corresponding to the malfunction of the operation during the autonomous driving being performed. Thus, appropriate control can be performed after the restart of the first control device.

In an aspect, the first control device may interrupt communication with the second control device and the base vehicle when the automatic mode is set after the restart.

In this way, when the automatic mode is set after the restart, there is a possibility that an unintended restart has been performed. Therefore, by interrupting the communication with the second control device and the base vehicle, it is possible to suppress the second control device and the base vehicle being affected by the operation of the first control device.

In a further aspect, the first control device may maintain communication with the second control device and the base vehicle when the manual mode is set after the restart.

In this way, when the manual mode is set after the restart, there is a possibility that an intended restart such as an update of software has been performed. Therefore, by maintaining the communication with the second control device and the base vehicle, it is possible to suppress the operation of the first control device being affected.

In a further aspect, the first control device may be configured to store history information when an activation switch of the vehicle indicates an operating state and the operating mode is the automatic mode, and interrupt communication with the second control device and the base vehicle when the history information is stored after the restart.

In this way, it is possible to suppress the second control device and the base vehicle being affected by the operation of the first control device.

According to the present disclosure, it is possible to provide a vehicle that enables appropriate control after restart of an interface between an autonomous driving system and the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a schematic configuration of a vehicle according to an embodiment of the present disclosure;

FIG. 2 is a diagram for describing a configuration and a function of a VCIB;

FIG. 3 is a flow chart illustrating an exemplary process executed by a control microcomputer; and

FIG. 4 is a time chart illustrating an operation example of the vehicle according to the embodiment of the present disclosure.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

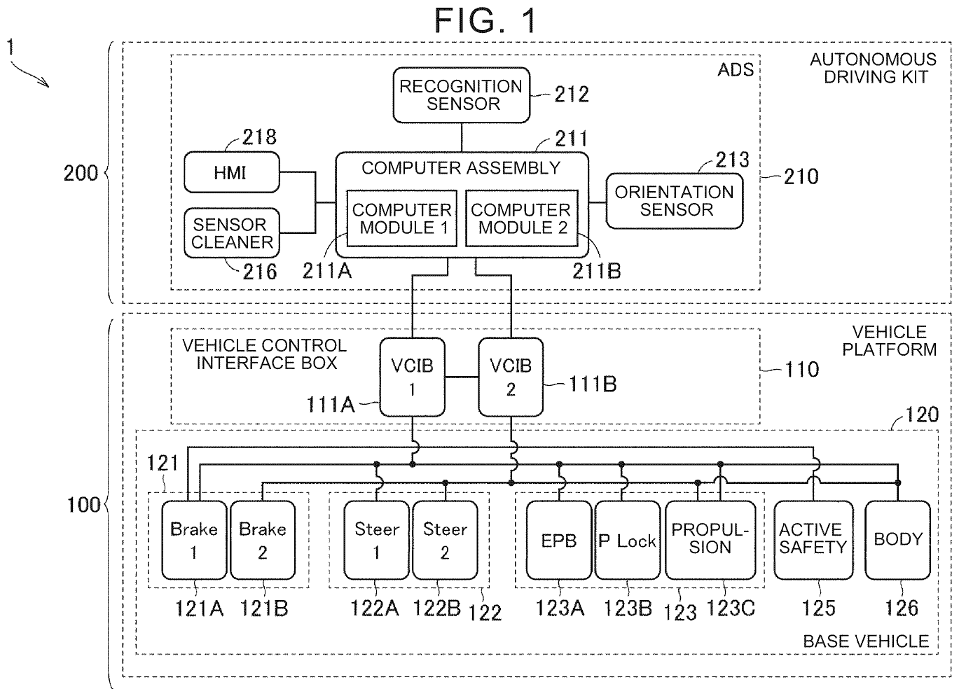

FIG. 1 is a diagram illustrating an exemplary schematic configuration of a vehicle according to an embodiment of the present disclosure. Referring to FIG. 1, the vehicle 1 includes a VP (vehicle platform) 100 and a detachable ADK (automated driving kit) 200. VP 100 includes a VCIB (Vehicle Control Interface Box) 110 and a base vehicle 120. Vehicles 1 capable of autonomous driving are configured by attaching an ADK 200 to a predetermined position (for example, a rooftop) of a VP 100. The base vehicle 120 is an electrified vehicle such as a battery electric vehicle or a hybrid electric vehicle.

ADK 200 includes an autonomous driving system (hereinafter referred to as “ADS”) 210 for performing autonomous driving of the vehicles 1. ADS 210 includes a computer assembly (hereinafter referred to as “CA”) 211, a recognition sensor 212, an attitude sensor 213, a sensor cleaner 216, and a Human Machine Interface (HMI) 218.

CA 211 includes a computer module (hereinafter referred to as “ADC”) 211A, 211B. Each of ADC 211A, 211B includes a processor and a storage device that stores autonomous driving software using a API, which will be described later, and is configured to be capable of executing autonomous driving software by the processor. The recognition sensor 212 acquires environment information indicating an external environment of the vehicle 1. The recognition sensor 212 may include at least one of a camera, a millimeter wave radar, and a lidar. The attitude sensor 213 acquires attitude information regarding the attitude of the vehicle 1. The attitude sensor 213 may include various sensors for detecting acceleration, angular velocity, and position of the vehicle 1. HMI 218 includes an inputting device and a notification device.

The base vehicle 120 includes a braking system 121, a steering system 122, a power train system 123, an active safety system 125, and a body system 126. In this embodiment, the electronic control unit (hereinafter also referred to as “ECU”) is provided.

VCIB 110 is configured to communicate with both the base vehicles 120 and ADK 200 via communication busses, such as by Controller Area Network (CAN) communication. In the vehicle 1, a control system related to the behavior (running, stopping, and bending) of the vehicle 1 has redundancy. ADC 211A, 211B gives instructions to the main-control system and the sub-control system, respectively. VCIB 110 includes a control unit (hereinafter referred to as “first VCIB”) 111A of the main-control system and a control unit (hereinafter referred to as “second VCIB”) 111B of the sub-control system. Each control unit includes a computer including a processor and a storage device.

The brake system 121 includes a braking device, a brake pedal, and a brake control unit 121A, 121B. The steering system 122 includes a steering device, a steering wheel, and a steering control unit 122A, 122B. The power train system 123 includes a shifting device, a vehicle driving device, and an Electric Parking Brake (EPB, a parking lock device (P-Lock device), an EPB control unit 123A, a P-Lock control unit 123B, and a propulsion control unit 123C. The shift device determines the shift range, and switches the propulsion direction and the shift mode of the vehicle 1 according to the shift range after the determination. The shift device includes a transmission and a shift lever. The vehicle driving device applies a propulsive force in a propulsion direction indicated by the shift range. The vehicle driving device includes a driving battery, a driving motor using the driving battery as a power supply source, and an accelerator pedal. P-Lock device further includes an actuator that operates the parking locking device and an operation unit that receives a parking operation.

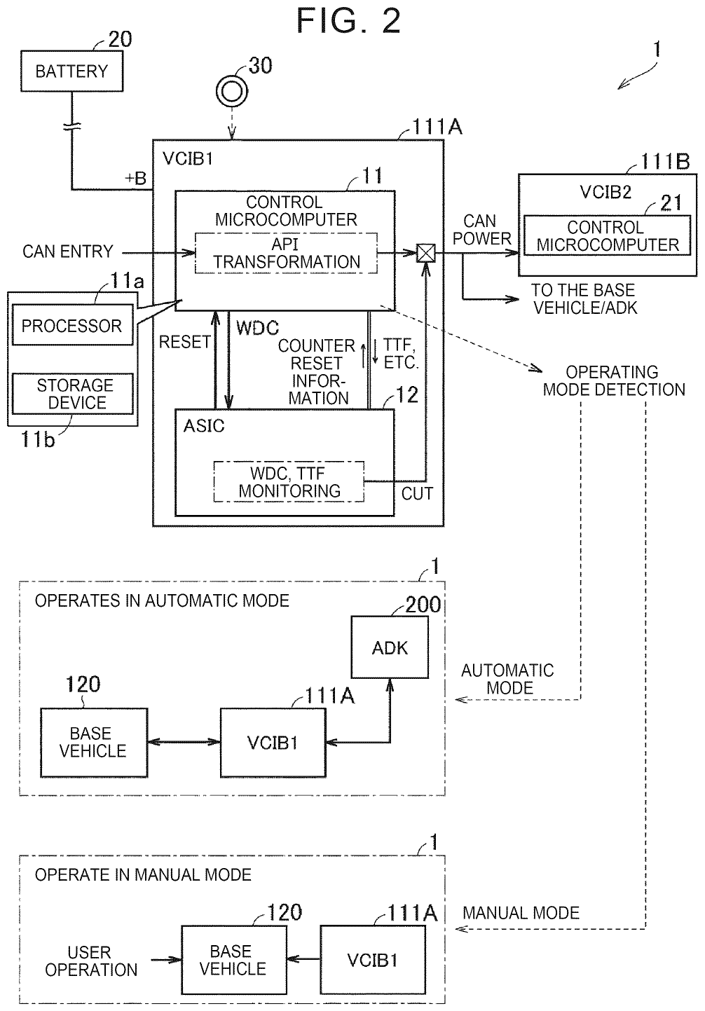

FIG. 2 is a diagram for describing a configuration and a function of a VCIB 110. Referring to FIG. 2, the first VCIB 111A includes a microcomputer (control microcomputer) 11 for control and an Application Specific Integrated Circuit (ASIC) 12.

The control microcomputer 11 includes a processor lla and a storage device 11b. The control microcomputer 11 receives power from the battery 20. The battery includes a drive battery, an auxiliary battery, and the like. DC/DC converters may be provided between the control microcomputer 11 and the battery 20. The storage device 11b includes Random Access Memory (RAM). The storage device 11b is supplied with electric power from a backup power source such as the battery 20.

ASIC 12 includes WDC (watchdog timer circuitry). WDC is configured to detect a fixed-period clock signal inputted from the control microcomputer 11 and monitor a normal operation of the control microcomputer 11. When the clock signal is not inputted to ASIC 12 within the timer period, ASIC 12 (WDC) determines that the control microcomputer 11 is operating abnormally and outputs a reset signal to the control microcomputer 11. The control microcomputer 11 that has received the reset signal is in the power-off state and restarts after the reset (microcomputer reset). The control microcomputer 11 and ASIC 12 perform Serial Peripheral Interface (SPI communication with each other. SPI communication is a synchronous serial communication that performs data communication in synchronization with clocks. The control microcomputer 11 transmits a time-to-fail (TTF) signal to ASIC 12 by SPI communication. ASIC 12 transmits the counter-reset data to the control microcomputer 11 by SPI communication.

The second VCIB 111B also includes a microcomputer (control microcomputer) 21 for control corresponding to the control microcomputer 11. The control microcomputer 21 includes a processor and a storage device. The control microcomputer 21 is also supplied with electric power from the battery 20. The control microcomputer 11 and the control microcomputer 21 perform CAN communication with each other. Each of the control microcomputers 11 and 21 is configured to be capable of CAN communication with both the base vehicle 120 and ADK 200.

In this embodiment, a signal (API signal) defined in Application Program Interface (API) is used for communication between ADK 200 and VCIB 110. ADK 200 is configured to process various types of signals defined in API. ADK 200 outputs various commands to VCIB 110 in accordance with API. Hereinafter, each of the various commands outputted from ADK 200 to VCIB 110 is also referred to as an “API command”. API commands include commands related to autonomous driving control. ADK 200 (ADC 211A,211B) determines API command-value. ADK 200 also receives from VCIB 110 various signaling indicative of the status of the base vehicle 120 in accordance with API. Hereinafter, each of the above-described various types of signals received by ADK 200 from VCIB 110 is also referred to as “API status”. Both API and API statuses correspond to API.

In this embodiment, ADK 200 uses API commands described below.

The vehicular mode command is an API command requesting a transition to an automated mode or a manual mode. ADK 200 can select the operation mode (vehicle mode) of the vehicle 1 using the vehicle mode command. The propulsion direction command is an API command requesting switching of a shift range (R/D). The acceleration command is an API command for instructing the acceleration of the vehicle. The acceleration command requests acceleration (+) and deceleration (−) with respect to a direction indicated by a propulsion direction status to be described later. The immobilization command is an API command requesting application or removal of immobilization. The application of immobilization means that EPB is in ON state (operating state) and the shift range is in the P (parking) state.

VCIB 110 receives various API commands from ADK 200. Upon receiving API command from ADK 200, VCIB 110 converts API command into a form of a signal executable by the controller of the base vehicle 120. Hereinafter, API command converted into the format of the signal executable by the control device of the base vehicle 120 is also referred to as an “in-house command”. When VCIB 110 receives API command from ADK 200, it outputs an inside command corresponding to API command to the base vehicle 120.

Next, API status will be described. ADK 200 grasps the status of the base vehicle 120 using, for example, API status described below.

The vehicle mode status is an API status indicating a vehicle mode status. The operation mode (vehicle mode) of the vehicle 1 includes a manual mode, an automatic mode, and a standby mode. The manual mode is an operating mode in which the vehicle is under the control of a driver (human). The automatic mode is an operating mode in which the vehicle platform (including the base vehicle) is under the control of the autonomous driving kit. The standby mode is an operation mode in which movement of the vehicle is prohibited. The driver can select a desired operation mode through the in-vehicle HMI. The base vehicle 120 selects the operation mode in consideration of the situation of the vehicle 1 and the selection of the driver. The vehicle mode status outputs corresponding values “0”, “1”, and “2” when the current operation mode is the manual mode, the automatic mode, or the standby mode.

The propulsion direction status is an API status indicating the present shift range. The traveling direction status is an API status indicating a traveling direction of the vehicle. In the traveling direction status, a value “0” is outputted when the vehicle moves forward, a value “1” is outputted when the vehicle moves backward, and a value “2 (Standstill)” is outputted when all the wheels (four wheels) continuously indicate the speed “0” for a predetermined time. The vehicle speed status is an API status indicating a vertical speed of the vehicle. The vehicle speed status outputs an absolute value of the vehicle speed. The immobilization status is an API status indicating a status of immobilization.

Some API statuses used in the vehicles I have been described above. VCIB 110 receives various sensor detection values and state determination results from the base vehicle 120, and outputs various API statuses indicating the state of the base vehicle 120 to ADK 200. VCIB 110 acquires API status in which the status indicating the status of the base vehicle 120 is set, and outputs the obtained API status to ADK 200.

The vehicle 1 further includes an activation switch 30 that receives a user operation for switching between the operation and the stop of VP 100 control system (including the control microcomputers 11 and 21 and various ECU of the base vehicle 120). When the user operates the activation switch 30, the control system of VP 100 is switched on (activated) and off (deactivated). When the control system is shut down, the activation switch 30 is turned off. In this embodiment, the ignition relation (IGR) (not shown) is switched on (closed) or off (open) according to the state (activation/deactivation) of the activation switch 30. The control microcomputer 11 is configured to be able to detect the state of the activation switch 30 (IGR state) and its own operating state. Hereinafter, the operation status of the control microcomputer 11 will be referred to as “inner IGR”. The control microcomputer 11 sequentially acquires the inside IGR. When the control microcomputer 11 is in the power-on state, the inner IGR indicates on (operating state). When the control microcomputer 11 is in a shutdown state or a power-off state, the inner IGR indicates off (stopped state). When the activation switch 30 is turned on, the control microcomputer 11 is activated and the power is turned on. The control microcomputer 11 starts the shutdown process by the off operation of the start-up switch 30, and when the shutdown process is completed, the control microcomputer 11 enters the power-off state.

In this embodiment, an interface computer included in VCIB 110 detects an operation mode selected from options including a plurality of types of operation modes, and outputs the detected operation mode to the base vehicle 120. The interface computer is hereinafter referred to as “IFCOM”. The plurality of types of operation modes are, for example, a manual mode, an automatic mode, and a standby mode. The control microcomputer 11 selects one of the control microcomputer 11 and the control microcomputer 21 as an IFCOM. For example, when the control microcomputer 11 is in a normal condition, the control microcomputer 11 is selected as an IFCOM. When the control microcomputer 11 is likely to be damaged, the control microcomputer 21 can operate as an IFCOM. Since both the control microcomputer 11 and the control microcomputer 21 can function as IFCOM, the robustness of VCIB 110 is increased.

IFCOM converts API commands from ADK 200 into internal commands, and outputs the obtained internal commands to the base vehicles 120 together with the operation modes. IFCOM acquires API status using the vehicle data from the base vehicle 120, and outputs the obtained API status to ADK 200. The operation mode is selected by, for example, one of the user, the base vehicle 120, and ADK 200. Further, the server outside the vehicle may switch the operation mode of the vehicle 1 as necessary. The control device of the base vehicle 120 controls the vehicle 1 according to the operation mode detected (acquired) by IFCOM.

The control microcomputer 11 periodically detects the selected operation mode and the state (operation/stop) of the activation switch 30. Each time an operation mode is detected, the control microcomputer 11 records operation mode information indicating the detected operation mode in the storage device 11b. When the control microcomputer 11 is restarted, the control microcomputer 11 detects the selected operation mode based on the operation mode information recorded immediately before the stop. In addition, both that the detected state of the activation switch 30 indicates activation (first requirement) and that the detected operation mode is the automatic mode (second requirement) may be satisfied. In this case, the control microcomputer 11 records predetermined information (history information) in the storage device 11b. When at least one of the first requirement and the second requirement is not satisfied, the control microcomputer 11 erases the history data in the storage device 11b. The historical information may be recorded by polling. Hereinafter, a state in which the storage device 11b stores the history information is referred to as “history ON”, and a state in which the storage device 11b does not store the history information is referred to as “history OFF”. The control microcomputer 11 determines whether or not the history is ON at the time of restart. When it is determined to be the history ON, ASIC 12 executes CAN cutting process after the control microcomputer 11 is restarted. During CAN cutting, CAN is cut off from the control microcomputer 11. As a result, communication between the control microcomputer 11, the control microcomputer 21, and the base vehicle 120 is interrupted.

In some cases, the control microcomputer 11 is restarted in a state in which the automatic mode is selected and the activation switch 30 indicates the operation (a state in which the operation is turned on). In this case, it is highly likely that the stop of the control microcomputer 11 was unintended. The unintended stop of the control microcomputer 11 is, for example, a stop caused by an internal abnormality of the control microcomputer 11 or a power supply abnormality. There is a possibility that the control microcomputer 11 is damaged. Therefore, in the above configuration, the communication between the control microcomputer 11 and the control microcomputer 21 is stopped, and the control microcomputer 21 is not affected by the control microcomputer 11. According to such a configuration, even if an abnormality occurs in the control microcomputer 11, the control microcomputer 21 can easily operate normally.

While the communication between the control microcomputer 11 and the control microcomputer 21 is stopped, the control microcomputer 11 selects the control microcomputer 21 as an IFCOM. On the other hand, when the control microcomputer 11 starts normally after the communication between the control microcomputer 11 and the control microcomputer 21 is stopped, the control microcomputer 11 releases the interruption

(CAN cutting) of the communication. At the same time, the control microcomputer 11 is selected as IFCOM. IFCOM periodically detects the selected operation mode and, each time the operation mode is detected, outputs the detected operation mode to the control device of the base vehicle 120. Similarly to the control microcomputer 11, the control microcomputer 21 may have a non-volatile storage device. The restarted control microcomputer 21 may detect the selected operation mode based on the operation mode information recorded in the storage device immediately before the stop. The base vehicle 120 recognizes the selected operating mode based on the information from IFCOM (VCIB 110). When the operation mode is not outputted from VCIB 110 to the base vehicle 120, the base vehicle 120 recognizes that the selected operation mode is the manual mode. The base vehicle 120 may activate the active safety system 125 to perform deceleration control of the vehicle 1 by the active safety system 125. Alternatively, the base vehicle 120 may notify the driver that the vehicle 1 is operating in the manual mode. In the following description, the information indicating the selected operation mode is referred to as an “inner VEMDST”. The base vehicle 120 sequentially acquires the internal VEMDST and controls the vehicle 1 according to the most recent internal VEMDST.

In the vehicle 1 as described above, the control microcomputer 11 may be restarted due to a malfunction or the like of the control microcomputer 11 during automatic driving. In this case, it is conceivable that the automatic mode is set as the initial value of the operation mode selected after the restart in order to continue the automatic operation even after the restart of the control microcomputer 11. However, the restart of the control microcomputer 11 may be performed by, for example, software update in addition to the malfunction of the operation. In such a case, if the auto-mode is set after the restart, the same control (i.c., CAN cutting) as in the case where the operation failure has occurred thereafter may be performed, and appropriate control may not be performed.

Therefore, in the present embodiment, the control microcomputer 11 sets the automatic mode when the operation mode acquired from the control microcomputer 21 after the restart of the control microcomputer 11 is the automatic mode. When the operation mode acquired from the control microcomputer 21 after the restart is the manual mode, the control microcomputer 11 sets the manual mode.

In this way, after the control microcomputer 11 is restarted, since the operation mode is set to the operation mode acquired from the control microcomputer 21, it is possible to quickly return to the operation mode before the restart. Therefore, even if the automatic mode is restarted due to a malfunction of the operation during the automatic operation, the automatic mode is continued after the restart, and it is possible to perform control corresponding to the malfunction of the operation during the automatic operation such as the communication with the control microcomputer 21 is stopped. Further, for example, in the case of being restarted by software update during the manual mode, since the manual mode is set after the restart, communication with the control microcomputer 21 is continued.

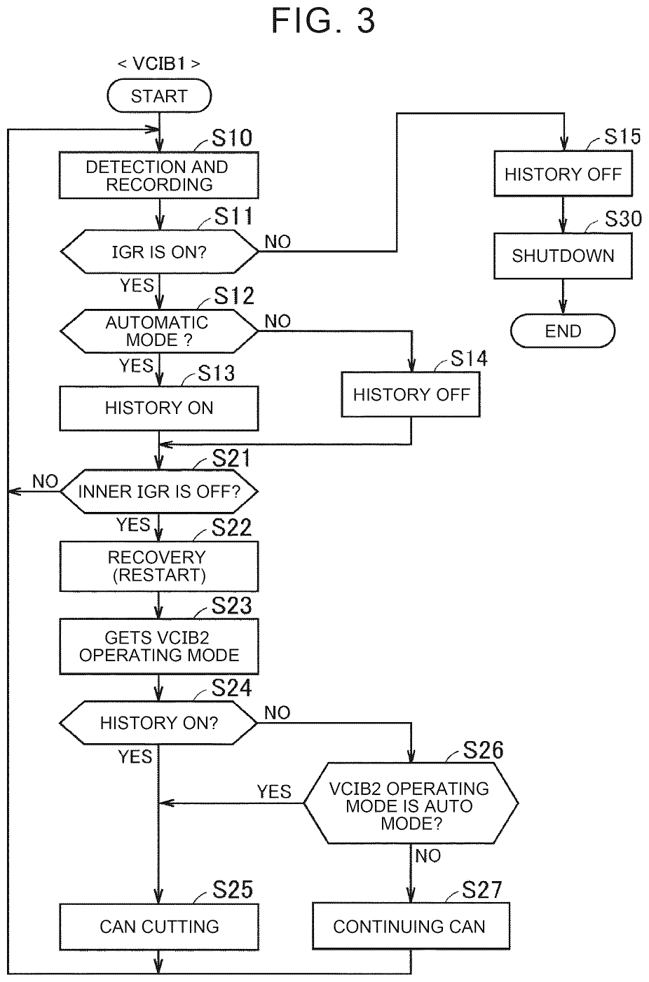

FIG. 3 is a flow chart illustrating an exemplary process executed by the control microcomputer 11. Hereinafter, each step in the flowchart will be referred to as “S”. When activated in a normal condition, the control microcomputer 11 selects the control microcomputer 11 as an IFCOM and starts S10 and the subsequent process flow (hereinafter, referred to as “S10 flow”).

In S10, the state of the activation switch 30 (IGR state) and the present operation mode (selected operation mode) are detected, and the detected result is recorded in the storage device 11b. As a result, the operation mode information indicating the detected operation mode is recorded in the storage device 11b. In the following S11, the control microcomputer 11 determines whether the ignition relation (IGR) is on-state or not. IGR being on-state (YES in S11) means that the first requirement is met. In S12, the control microcomputer 11 determines whether or not the operation mode detected by S10 is the auto mode. The fact that the detected operation mode is the auto mode (YES in S12) means that the second requirement is satisfied. If both the first requirement and the second requirement are satisfied (YES in both S11,S12), the control microcomputer 11 sets the history ON in S13. Thereafter, the process proceeds to S21. When the first requirement is satisfied and the second requirement is not satisfied (YES in S11 and NO in S12), the control microcomputer 11 sets the history OFF in S14. Thereafter, the process proceeds to S21. When the first requirement is not satisfied (NO in S11), the control microcomputer 11 sets the history OFF in S15. Thereafter, the process proceeds to S30. The control microcomputer 11 causes RAM to store information about the on/off status of the history. The information about the on-off state of the history is set to an initial value (a value indicating the history-off state in the present embodiment) when RAM is initialized.

In S21, the control microcomputer 11 acquires the present internal IGR and determines whether or not the obtained internal IGR indicates off-state. When the inner IGR indicates ON (NO in S21), the control microcomputer 11 is highly likely to be normal, and thus the process returns to S10. The control microcomputer 11 operates as an IFCOM while executing a process from S10. On the other hand, when the inner IGR is turned off while satisfying the first requirement (YES in S21), the control microcomputer 11 is stopped under some circumstances. In this instance, the control microcomputer 11 returns (restarts) in the subsequent S22. Further, the returned control microcomputer 11 acquires the operation mode of the control microcomputer 21 in a subsequent S23. The control microcomputer 11 acquires, for example, information about the current operation mode from the control microcomputer 21. In the following S24, it is determined whether or not the control microcomputer 11 is in a history ON. If it is determined that there is a history OFF (NO in S24), the process proceeds to S26. On the other hand, when it is determined that there is a history ON (YES in S24), the process proceeds to S25. In S25, ASIC 12 executes CAN cutting process based on the control microcomputer 11. As a result, communication between the control microcomputer 11 and each of the control microcomputer 21 and the base vehicle 120 is interrupted. The process then returns to S10.

In S26, the control microcomputer 11 determines whether or not the present operation mode in the control microcomputer 21 is the auto mode. When it is determined that the present operation mode in the control microcomputer 21 is the auto mode (YES in S26), the process is shifted to S25. On the other hand, when it is determined that the present operation mode in the control microcomputer 21 is the manual mode (NO in S26), the process proceeds to S27. In S27, CAN communication between the control microcomputer 11 and the control microcomputer 21 is continued. The process then returns to S10.

When CAN cutting process is executed and the control microcomputer 21 is activated, the vehicles 1 are operated in the auto-mode. The control microcomputer 21 may execute stop control (safety stop control) of the vehicles 1 according to an instruction from ADK 200 in the auto-mode. After the vehicle 1 stops, the control microcomputer 21 may restart the control system. Alternatively, the control microcomputer 21 may request the user to operate the activation switch 30 for restarting the control system. Thus, the control system (including the control microcomputer 11) of the vehicle 1 is restarted. However, the present disclosure is not limited thereto, and the active control microcomputer 21 may continue the traveling of the vehicle 1 in the automatic mode. The control microcomputer 21 may execute, for example, an automatic driving control similar to the control microcomputer 11 or a more limited automatic driving control. The limit may be a speed limit.

When the activation switch 30 is turned off by the user in any of the active/inactive states of the control microcomputer 11, it is determined that S11 is NO, and in S30, the control microcomputer 11 executes a shutdown process. When the shutdown process is completed, the control microcomputer 11 is powered off, and S10 process ends.

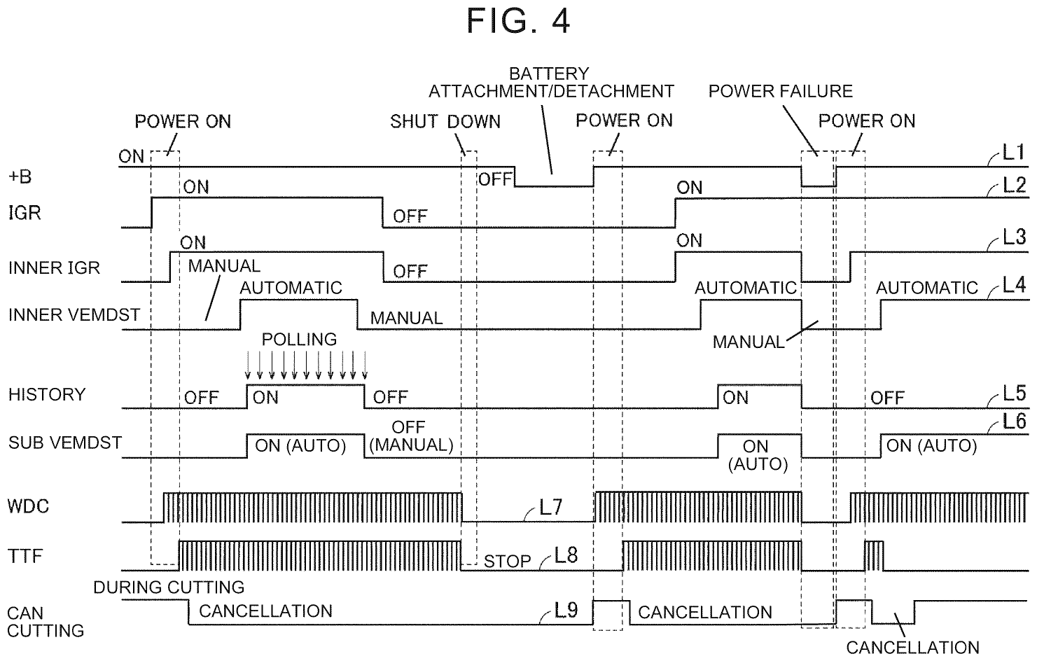

The operation of VCIB 110 based on the above-described configuration and flow chart will be described referring to FIG. 4. FIG. 4 is a diagram illustrating an operation of the vehicle 1 according to the embodiment of the present disclosure. From the line L1 of FIG. 4, L9 shows the status transition of the control microcomputer 11. Specifically, the line L1 indicates whether power is supplied to the control microcomputer 11, and the line L2 indicates the status of IGR. The line L3 indicates the state of the inner IGR, and the line L4 indicates the state of the inner VEMDST. The line L5 indicates the state of the history, and the line L6 indicates the state of the operation mode (sub VEMDST) acquired from the control microcomputer 21. Line L7 indicates a change in the clock signal with respect to WDC, line L8 indicates a change in TTF signal, and line L9 indicates the presence or absence of a CAN cut.

As shown by the line L1 of FIG. 4, when the power supply to the control microcomputer 11 is stopped (power failure), the control microcomputer 11 is restarted when the power supply is resumed. At this time, as indicated by the line L2, the state in which IGR is on is maintained, and the inner IGR changes to the on state as the power is stopped, as indicated by the line L3. As shown in the line L4, when the control microcomputer 11 is restarted while the vehicle 1 is operating in the auto mode, the history data stored in the back-up RAM is initialized as indicated by the line L5 in of FIG. 4, and thus the control microcomputer changes to the off-state. Therefore, S26 process of FIG. 3 is executed. That is, it is determined whether or not the current operation mode of the control microcomputer 21 is the automatic mode. Since the present operation mode of the control microcomputer 21 is the automatic mode as indicated by the line L6 of FIG. 4, as indicated by L9 of FIG. 4, CAN cutting process is executed. Here, IFCOM is switched from the control microcomputer 11 to the control microcomputer 21. Therefore, the vehicle 1 resumes the operation in the automatic mode.

On the other hand, for example, when the software update is performed in the control microcomputer 11 while the vehicle 1 is operating in the manual mode, the control microcomputer 11 is restarted after the software update process is completed. When the control microcomputer 11 is restarted while the vehicle 1 is operating in the manual mode, the information of the history stored in RAM is initialized, and thus the information of the history changes to the off-state. Therefore, S26 process of FIG. 3 is executed. That is, it is determined whether or not the current operation mode of the control microcomputer 21 is the automated mode, and since the current operation mode of the control microcomputer 21 is the manual mode, CAN communication is continued. Here, the control microcomputer 11 is maintained as IFCOM.

When the battery 20 is replaced (detached) while the vehicle 1 is operating in the manual mode, the control microcomputer 11 is restarted in the history OFF. Therefore, S25 process of FIG. 3 is not executed, and since the operation mode is the manual mode, CAN communication is continued.

As described above, according to the vehicle 1 of the present embodiment, since the operation mode is set to the operation mode acquired from the control microcomputer 21 after the restart, it is possible to quickly return to the operation mode before the restart. Therefore, even if restarted due to a malfunction of the operation during the automatic operation, the automatic mode can be continued after the restart. Therefore, it is possible to perform the control corresponding to the malfunction of the operation during the automatic operation after the restart. For example, if the automatic mode is set after a restart, an unintended restart may have occurred. Therefore, by interrupting the communication between the control microcomputer 21 and the base vehicle 120, it is possible to suppress the control microcomputer 21 and the base vehicle 120 from being affected by the operation of the control microcomputer 11. Further, for example, in the case of being restarted by updating the software during the manual mode, since the manual mode is set after the restart, the control corresponding to the malfunction of the operation during the automatic operation is suppressed from being performed. For example, when the manual mode is set after the restart, there is a possibility that an intended restart such as an update of software is performed. Therefore, the communication between the control microcomputer 21 and the base vehicle 120 is maintained, whereby the communication between the control microcomputer 11 and the base vehicle 120 is unnecessarily interrupted. The recording of the communication abnormality in the base vehicle 120 is suppressed. Effects on the operation of the control microcomputer 11 are suppressed. Therefore, it is possible to provide a vehicle capable of performing appropriate control after the interface between the autonomous driving system and the vehicle is restarted.

Further, if the history information is stored after the restart, there is a possibility that an unintended restart has been performed. Therefore, by stopping the communication with the control microcomputer 21, it is possible to suppress the control microcomputer 21 from being affected by the operation of the control microcomputer 11.

The vehicle 1 according to this embodiment records the operation mode information in the backup RAM. By using the backup RAM as the storage device 11b, the operation mode data recorded in the backup RAM immediately before the control microcomputer 11 is stopped is held even after the control microcomputer 11 is restarted. Backup RAM have the benefit of faster accessing rates compared to non-volatile memory, such as flash memory. Further, the data stored in the back-up RAM can be read at any timing immediately after activation of the control microcomputer 11, and can be initialized as needed. However, the present disclosure is not limited thereto, and a nonvolatile memory such as a flash memory may be employed as the storage device 11b.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A vehicle comprising:
an autonomous driving system that performs autonomous driving of the vehicle; and
a vehicle platform that is able to receive a command related to the autonomous driving from the autonomous driving system, wherein:
the vehicle platform is subjected to vehicle control executed in an operation mode that is one of an automatic mode in which the autonomous driving system is used and a manual mode;
the vehicle platform includes a base vehicle and a vehicle control interface that interfaces between the vehicle platform and the autonomous driving system;
the vehicle control interface includes
a first control device that is able to control the base vehicle according to the operation mode, and
a second control device that is able to communicate with the first control device and is able to control the base vehicle according to the operation mode; and
the first control device is configured to
set the automatic mode when the operation mode acquired from the second control device after restart of the first control device is the automatic mode, and
set the manual mode when the operation mode acquired from the second control device after the restart is the manual mode.

2. The vehicle according to claim 1, wherein the first control device interrupts communication with the second control device and the base vehicle when the automatic mode is set after the restart.

3. The vehicle according to claim 1, wherein the first control device maintains communication with the second control device and the base vehicle when the manual mode is set after the restart.

4. The vehicle according to claim 1, wherein the first control device is configured to
store history information when an activation switch of the vehicle indicates an operating state and the operating mode is the automatic mode, and
interrupt communication with the second control device and the base vehicle when the history information is stored after the restart.
